(19) United States
(12) Patent Application Publication
(10) Pub. No.: US 2011/0005663 A1
(43) Pub. Date: Jan. 13, 2011

(54) Method of durably grafting a decorated fabric to a cloth such as jeans with stencil

(76) Inventor: Inkyun Kim, Arcadia, CA (US)

Correspondence Address: Inkyun Kim, 225 W. Carminoreal Ave., Arcadia, CA, 91007, US

(21) Appl. No.: 12/313,795

(22) Filed: Nov. 25, 2008

(51) Int. Cl. B29C 65/02

(52) U.S. Cl. 156/155

(57) ABSTRACT

A meted of durably grafting a decorated fabrics to a cotton cloth such as jeans or denim is comprised of; 1) first step of printing a pattern with first stencil on a clothes that covers a supporting plate of an automatic printing machine, 2) second step of pasting an alkali solution along the outer line of the pattern on the clothes with second stencil, 3) third step of pasting a grafting glue along the outer line of the pattern that is printed on the clothes, 4) fourth step of pasting a water-soluble glue on one side a fabric, 5) fifth step of pasting a burn out gel on the fourth stencil that is overlapped over the fabric attached clothes, 6) sixth step of taking out the fabric attached clothes from the supporting plate of the automatic printing machine and drying the fabric attached clothes on a dryer at 160° C. over 2 minutes, 7) seventh step of heating and pressing the fabric attached clothes between a heating press and press longer than 5 seconds at 160° C., and 8) eighth step of removing the left of burn out from the grafted fabric by washing with washing machine. This technology can be applied to other artificial fabrics.

### FIELD OF THE INVENTION

Current application relates to a method of durably gluing fabrics each other, especially relates to a method of durably gluing a decorated fabric to another cloths such as blue jeans made of 100% cotton.

### BACKGROUND OF THE INVENTION

Jeans, blue jeans, became a heritage of human culture representing youth culture. They spread throughout the whole world and every youngster already has at least one of it or wants to have one. Now, jeans take a big portion in fashion industry. Recently, many kind of technologies are introduced to decorate jeans to meet requirements of young customers. However, due to the characteristics of the material, 100% cotton, method of decorating jeans are limited. Customers' requirement asking various different designs makes it more difficult. Printing might be the easiest way for decorating jeans with various designs. But, repeated washing deteriorates the drawings. Embroidering is the most durable and popular method of decorating the jeans. But, production cost for various designs is high. Gluing may be one of the cheap and convenient methods of grafting jeans with designed fabrics if it is durable. It is purpose of the current application to develop a method of durably gluing decorated fabrics to other cotton cloths such as blue jeans by applying many kind of materials as a gluing agent.

### DESCRIPTION OF PRIOR ART

U.S. Pat. No. 5,758,588 to Orfali illustrates an applique such as a lace-trimming is grafted onto a region of a textile product, such as a towel or a pair of blue-jeans.

U.S. Pat. No. 4,860,387 to Williams illustrates a decorated garment (11) has a plurality of doll figures (12,13,14) mounted on its front surface. Articles of clothing (26) for each of the doll figures are adapted to be attached to the doll figures to provide decorative wardrobes for the doll figures.

U.S. Pat. No. 5,087,664 to Sugino, et al. Illustrates a plastisol composition comprising a vinyl chloride polymer, a plasticizer and an adhesion-imparting agent, characterized in that the adhesion-imparting agent is a diisocyanate polymer blocked with an oxybenzoic acid ester or with an alkylphenol and having an average molecular weight within a range of from 1,000 to 10,000.

None of the prior art illustrates a method of grafting 100% cotton fabric onto 100% cotton cloths such as blue jeans to produced a glued cotton wear durable over 1,000 times mechanical washing.

### SUMMARY OF THE INVENTION

Jeans, blue jeans, became a heritage of human culture representing youth culture. Recently, many kind of technologies are introduced to decorate jeans to meet requirements of young customers. However, due to the characteristics of the material, 100% cotton, method of decoration jeans are limited. Printing might be the easiest way for decorating jeans with various designs. But, repeated washing deteriorates the drawings. Embroidering is the most durable and popular method of decorating the jeans. But, production cost for various designs is high. Gluing may be one of the cheap and convenient methods of grafting jeans with designed fabrics if it is durable. It is purpose of the current application to develop a method of durably gluing decorated fabrics to other cotton cloths such as blue jeans by applying many kind of materials as a gluing agents. A meted of durably grafting a decorated fabrics to a cotton cloths such as jeans or denim is comprised of; 1) first step of printing a pattern with first stencil on a clothes that covers a supporting plate of an automatic printing machine, 2) second step of pasting an alkali solution along the outer line of the pattern on the clothes with second stencil, 3) third step of pasting a grafting glue along the outer line of the pattern that is printed on the clothes, 4) fourth step of pasting a water-soluble glue on one side a fabric, 5) fifth step of pasting a burn out gel on the fourth stencil that is overlapped over the fabric attached clothes, 6) sixth step of taking out the fabric attached clothes from the supporting plate of the automatic printing machine and drying the fabric attached clothes on a dryer at 160° C. over 2 minutes, 7) seventh step of heating and pressing the fabric attached clothes between a heating press and press longer than 5 seconds at 160° C., and 8) eighth step of removing the left of burn out from the grafted fabric by washing with washing machine.

### BRIEF DESCRIPTION OF DRAWINGS

FIG. 1-1 is a schematic drawing of method of producing a patterned stencil of prior art.

FIG. 1-2 is a schematic drawing of prior art of printing method utilizing stencil.

FIG. 1-3 is a schematic drawing of method of prior art producing a patterned fabric grafted clothes utilizing a stencil of prior art.

FIG. 2 is a schematic drawing of printing a pattern on a clothes with first the stencil according to current invention.

FIG. 3 is a schematic drawing of pasting alkali solution along the outer-line of the pattern printed on the clothes utilizing a second stencil according to current invention.

FIG. 4 is a schematic drawing showing pasting grafting glue along the outer-line of the pattern printed on the clothes utilizing a third stenciled according to current invention.

FIG. 5 is a schematic drawing showing spraying water soluble glue on a fabric's surface according to the current invention.

FIG. 6 is a cross-sectional view of overlapped water-soluble glue sprayed fabric and grafting glue pasted along the outer-line of the pattern on the clothes according to the current invention showing the water-soluble glue covers larger area than the grafting glue to hold the fabric in position on the cloth.

FIG. 7 is a schematic drawing of pasting burnout gel on the fourth stencil to cut out the fabric along the outer-line of the pattern formed in the stencil.

FIG. 8 a schematic cross-sectional view of the overlapped cloths and the fabric showing the grafting glue smeared into the woven structure of the fabric and the clothes according to the current invention.

FIG. 9 is a schematic cross-sectional view of the overlapped cloths and the fabric showing the grafting glues starts grafting and become a grafted polymer according to the current invention.

### DETAILED DESCRIPTION OF THE PREFERRED EMBODIMENT

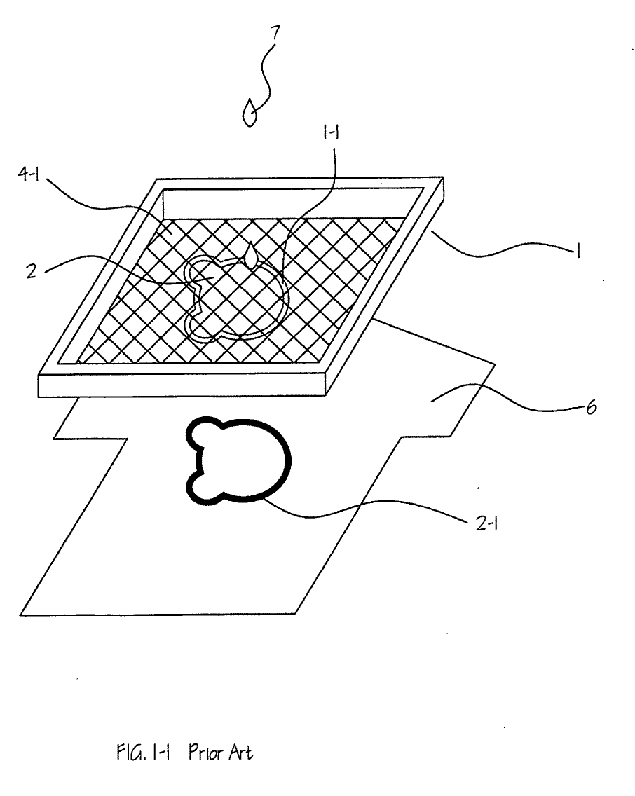

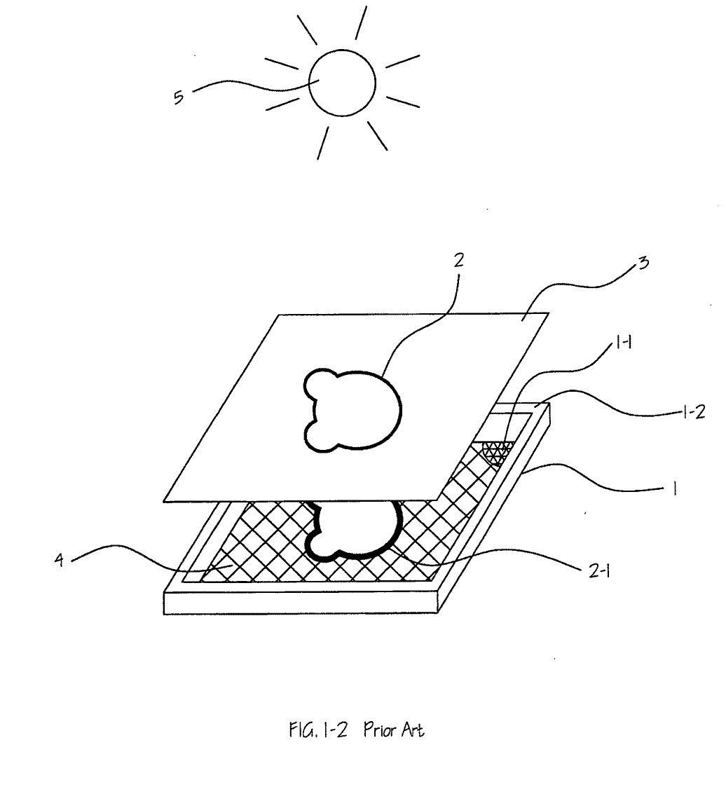

FIG. 1-1 is a schematic drawing of method of producing a patterned stencil (1) of prior art. The stencil (1) is usually comprised of screen (1-1) polyester of mesh size from 50 mesh to 100 mesh supported on a frame (1-2). Typical method is to draw a pattern (2) on a transparent film (3) of PET (Polyethylene Terephthalate). Then place the film (3) over a stencil (1), on which layer of light sensitive chemical (4) is pasted, and expose to a strong light (5). Then the pattern (2) is projected to the stencil (1) and forms a shadow (2-1) on the stencil (1). Then the light sensitive chemical (4) layer is hardened while the shadow (2-1) area remains unchanged. After wash out the unchanged chemical (4) layer, the screen (1-1) mesh is exposed from the shadow (2-1) area of FIG. 1-1. Such, pattern (2) containing, stencil (1) used for printing a clothes or cutting out patterns from fabrics.

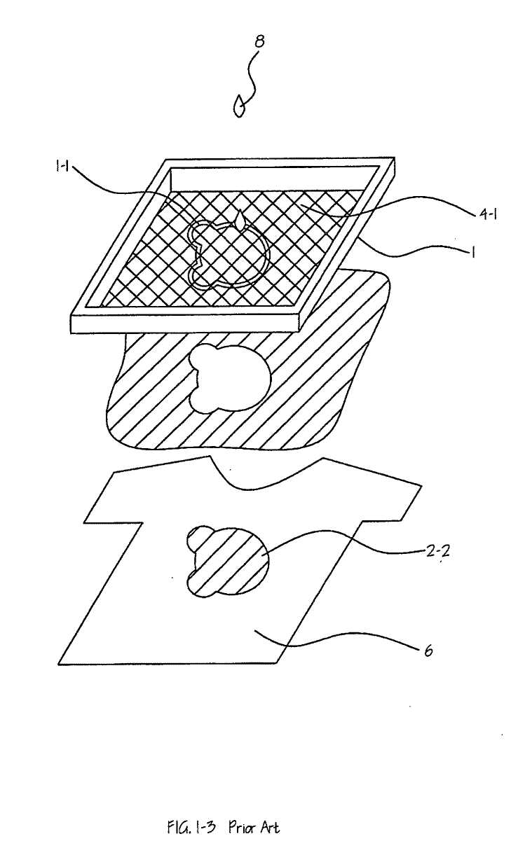

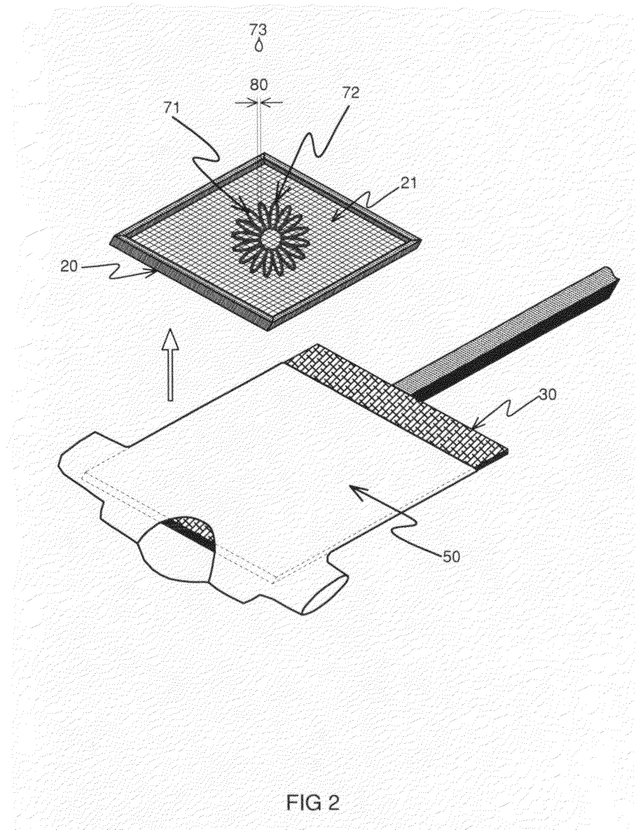

FIG. 1-2 is a schematic drawing of prior art of printing method-utilizing stencil (1). For printing, desired ink (7) is applied to the pattern (2) containing stencil. The ink (7) pass through the mesh (1-1) of the patterned area and print a patterned drawing (2-1) on a clothes (6). The printed clothes (6) can be used as a final product. However, the printed pattern (2-1) may fade out by repeated laundry. So, people think about attaching decorated fabrics to clothes by sewing the fabrics directly to the clothes.

FIG. 1-3 is a schematic drawing of method of prior art producing a patterned fabric grafted clothes utilizing a stencil of prior art. A burn out gel (8), which is a mixture of natural alginate, strong acid of printgen® OP-30PS, glycerin and water, is applied to the stencil (1) to cut patterned patch (2-2) out of a fabric. The cut out patch (2-2) is overlapped on the cloth (6), where the pattern (2) is printed, and is adhered by proper method, sewing is typical. To sew the patch (2-2), the clothes (6) should move to sewing machine. As described above, grafting clothes with patterned patch of fabric by previous method is very cumbersome job.

It is purpose of the current application to provide a simple method to manufacture a durably grafting decorated fabrics to cotton cloths such as blue jeans by gluing. Then, all procedure can be finished with same machines.

Difference of the current invention from the prior art the procedure of manufacturing a durably grafting decorated fabric to cotton cloths is as follows; The first step is to print a pattern (71) on a cloth (50). The cloth (50) is made of, including but not limited to 100% cotton. FIG. 2 is a schematic drawing of printing a pattern (71) on a cloth (50). This step is same as the FIG. 1-2 prior art. An automatic printing machine was used for this invention. Pluralities of supporting plates (30) are connected to the automatic printing machine. The supporting plate (30) of the automatic printing machine is inserted to the clothes (50), which is to be printed, to hold the clothes (50) in position. The first stencil (20) is overlapped on the clothes (50) and pasted with ink (73) to print the pattern (71) on the clothes (50).

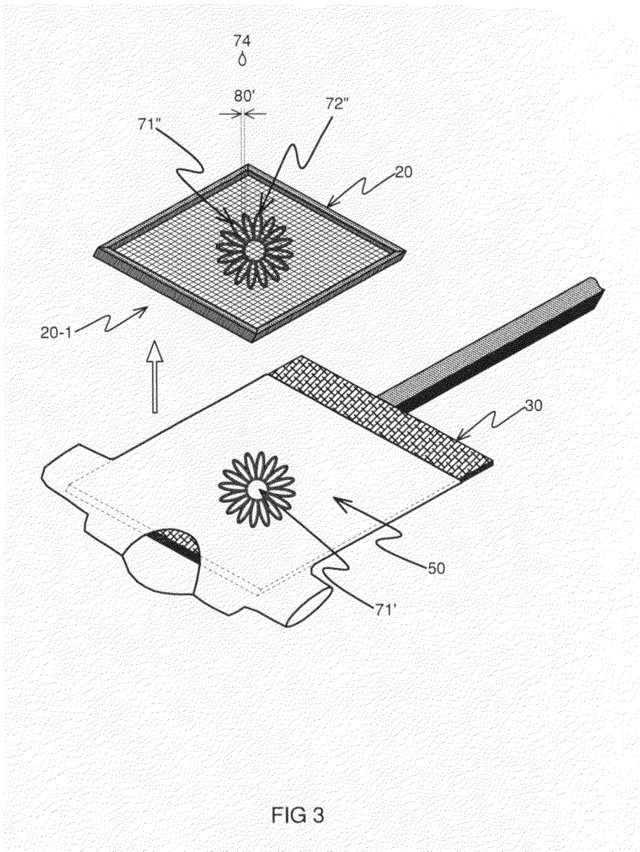

The second step is to paste an alkaline solution (74) along the outer line (72′) of the pattern (71′) printed on the clothes (50) utilizing a second stencil (20-1) as shown in the FIG. 3. The second stencil (20-1) may be the same as the first stencil (20) in the first step or has same pattern (71″) with that (71) in the first stencil (20) but only the thickness (80′) of the outer line (72″) is different from the thickness (80) of the outer line (72) of the pattern (71) on the first stencil (20).

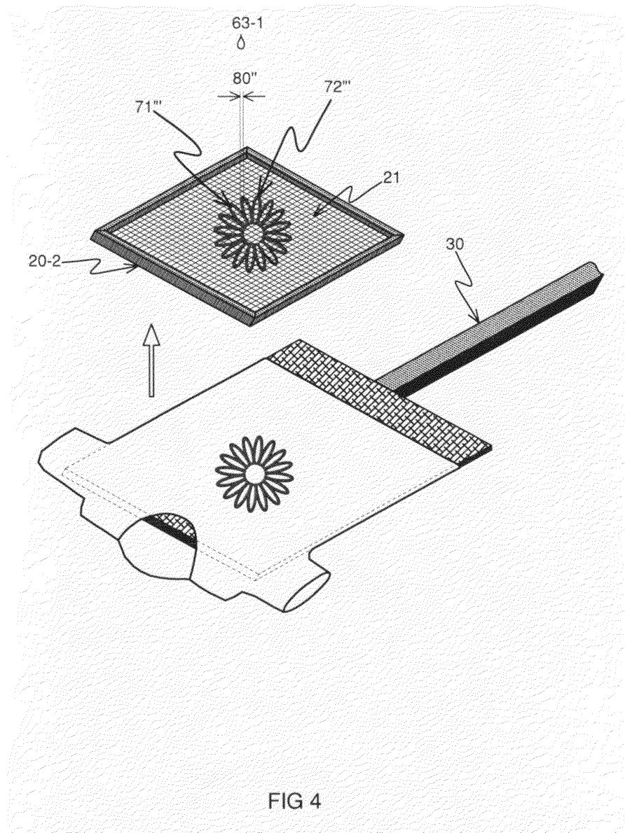

The third step is to paste a grafting glue (63-1) along the outer line (72′) of the pattern (71′) that is printed on the clothes (50) utilizing a third stencil (20-2) as shown in the FIG. 4. In this step, the third stencil (20-2) may be same as one or two of the previous ones (20), (20-1) or has same pattern (71), (71″), (71′″) but the thickness (80″) of the outer line (72′″) of the pattern (71′″) may be different from the former outer lines (72), (72″), (72′″). Polyone S11111 seriesone clear from Polyone Corporation is used for the grafting glue (63-1). It contains 1 to 5% of fume silica for inhibitor. Therefore, the grafting glue (63-1) remains liquid before the glue (63-1) is heated above a certain temperature.

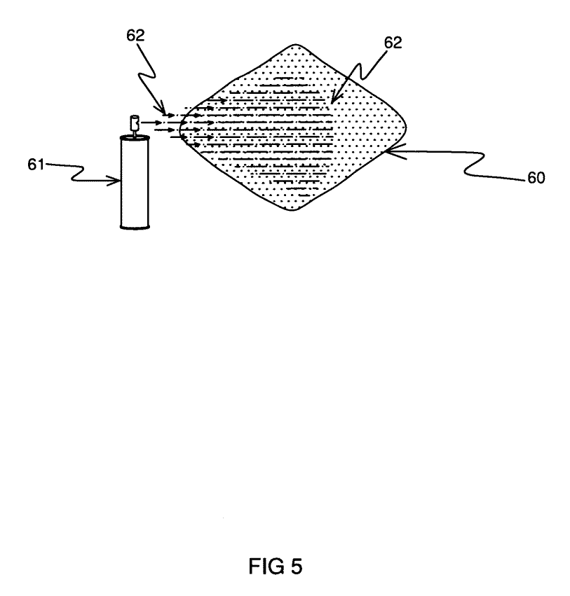

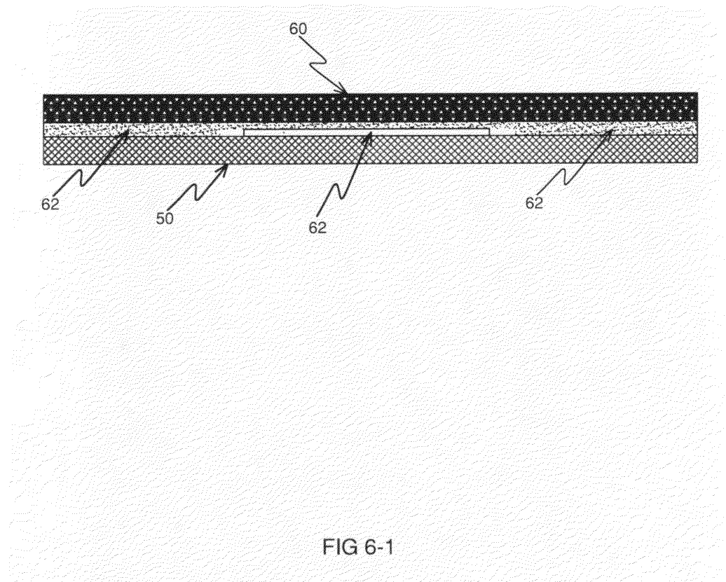

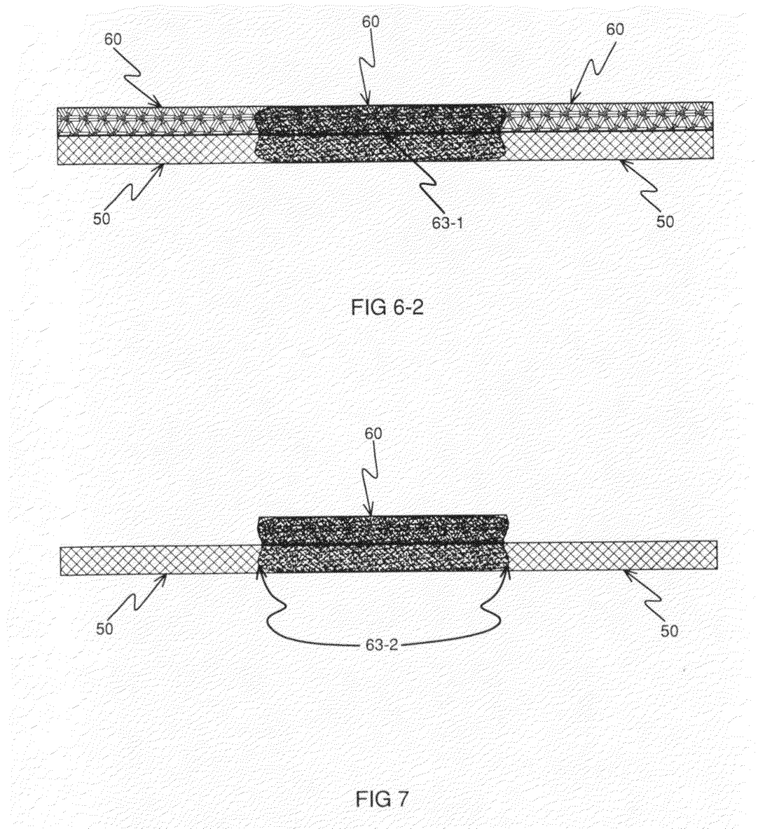

The fourth step is to paste a water-soluble glue (62) on a fabric (60) as shown in the FIG. 5. The fabric (60) is made of, including but not limited to 100% cotton. The size of the fabric (60) is at least two times larger than the size of the pattern (71) printed on the clothes (50). The water-soluble glue (62) is starch glue solution bottled in a spray can (61). The water-soluble glue (62) is sprayed over whole area of one side of the fabric (60). The fabric (60) may contain artificial 25 fabrics such as polyester, etc. FIG. 6-1 shows the cross sectional view of the over-lapped layer of the fabric (60) and the clothes (50).

The fifth step is to paste burn out gel (90) on the fourth stencil (20-3) as shown in the FIG. 7. The burnout gel (90) is a mixture of natural alginate, strong acid of printgen® OP-30PS, glycerine, and water. The burn-out gel (90) pass through the out line (72″″), which is just a mesh screen, of the pattern (71″″) on the fourth stencil (20-3) and burn out the fabric (60) along the out line (72″″) of the pattern (71″″) thereon. In this step, the fourth stencil (20-3) may be same as one of the previous ones (20), (20-1), (20-2) or has same pattern (71), (71″), (71′″), (71″″) but the thickness (80′″) of the outer line (72″″) of the pattern (71″″) may be different from the former outer lines (72), (72″), (72′″).

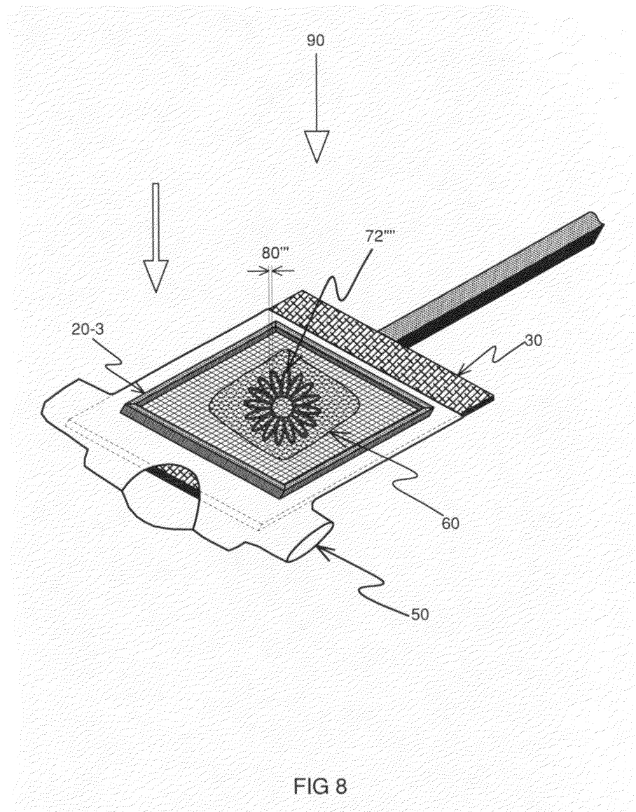

The sixth step is to take out the fabric (60) attached and the pattern (71′) printed cloth (50) from the support plate (30) and dry on a dryer at 160° C. for longer than 2 minutes. In this step, the water-soluble glue (62) is dried out and the grafting glue (63-1) smeared into woven structure of the fabric (60) and the clothes (50) as shown in the FIG. 8. According to the Polyone's catalogue the Plastisols contains PVC (Polyvinylchloride) resins. Based on the material safety data sheet and catalogue of the Polyone corporation and Sugino, et al.'s U.S. Pat. No. 664', when the grafting (63-1) glue is pasted on the fabric (60) or on the (50) clothes at room temperature, it is sol-type oligomer. But, when heat is applied its viscosity is lowered first and penetrates and smeared into the clothes as shown in the FIG. 8.

The seventh step is to place the stencil the fabric (60) attached and the pattern (71) printed cloth (50, which was dried in the fifth step, between a heating press and press for at least 5 seconds at 160° C. During this heating step, the FIG. 9. Now, the fabric (60) and the clothes (50) are strongly adhered by the grafted polymer (63-2).

The ninth step is to remove the left of burn out from the grafted fabric (60) by water washing. In the water washing step, marble washing is applied to make the fabric (60) grafted clothes (50) look like used denim.

For the above step, the clothes and fabric may be polyester, nylon and any other artificial fabrics.

Durability of the grafted fabric (60) on the clothes (50) is tested by laundering and drying repeatedly. Even after 100 times of machine laundering, the fabric (60) solidly attached to the clothes (50).

Among many different fabrics and clothes, 100% cotton fabric and 100% cotton clothes showed the best results.

What is claimed is

1. A method of durably grafting fabrics to clothes such as jeans with stencil is comprised of eight steps of;
first step of printing a pattern on a cloth using first stencil and an automatic printing machine which has pluralities of supporting plates that are inserted into the clothes to hold the clothes, and
second step of pasting an alkaline solution along the outer line of the pattern printed on the clothes utilizing a second stencil, which is the same stencil in the first step, and
third step of pasting a grafting glue of Polyone S11111 series-one clear, which contains 1 to 5% of fume silica for inhibitor, from Polyone Corporation, along the outer line of the pattern that is printed on the clothes utilizing a third stencil, which is the same the previous stencils, and
fourth step of spraying a water-soluble glue of starch glue solution in a spray can on one side of whole area of a fabric that is at least two times larger than the size of the pattern that is printed on the cloth, and
fifth step of pasting burn out gel, which is a mixture of natural alginate, strong acid of printgen® OP-30PS, glycerine, and water, on the fourth stencil, which is the same as the previous stencils, to allow the burn-out gel pass through the out line, which is just a mesh screen, of the pattern on the fourth stencil and burn out the fabric along the out line of the pattern thereon, and,
sixth step of taking out the fabric attached and the pattern printed cloth from the support plate and dry on a dryer at 160° C. for 2 minutes to allow the water-soluble glue dried out and the grafting glue smeared into woven structure of the fabric and the clothes, and
seventh step of placing the fabric attached and the pattern printed cloth between a heating press and press for 5 seconds at 160° C. to allow the grafting glue become a grated polymer, and
eighth step of removing,the left of burn out from the grafted fabric by washing with water.

2. A method of durably grafting decorated fabrics to a cloth such as jeans with stencil in claim 1 wherein, the second stencil has same pattern with that in the first stencil but only the thickness of the outer line is different from the thickness of the outer line of the pattern on the first stencil.

3. A method of durably grafting decorated fabrics to a cloth such as jeans with stencil in claim 1 wherein, the third stencil has same pattern with that in the second stencil but only the thickness of the outer line is different from the thickness of the outer line of the pattern on the second stencil.

4. A method of durably grafting decorated fabrics to clothes such as jeans with stencil in claim 1 wherein, the fourth stencil has same pattern with that in the third stencil but only the thickness of the outer line is different from the thickness of the outer line of the pattern on the third stencil.

5. A method of durably grafting decorated fabrics to clothes such as jeans with stencil in claim 1 wherein, the grafted fabric is durably attached to the clothes even after 100 times of machine laundry.

6. A method of durably grafting decorated fabrics to clothes such as jeans with stencil in claim 1, where in the fabrics is made of 100% cotton.

7. A method of durably grafting decorated fabrics to clothes such as jeans with stencil in claim 1, wherein the clothes is made of 100% cotton.

8. A method of durably grafting decorated fabrics to clothes such as jeans with stencil in claim 1, wherein the fabrics is made of polyester.

9. A method of durably grafting decorated fabrics to clothes with stencil in claim 1, wherein the clothes is made of polyester.

10. A method of durably grafting decorated fabrics to a clothes such as jeans with stencil in claim 1, marble wash is applied at the eighth step of washing.
